(19) United States
(12) Patent Application Publication
(10) Pub. No.: US 2011/0162936 A1
(43) Pub. Date: Jul. 7, 2011

(54) PARKING LOCK DEVICE FOR MOTOR VEHICLE

(75) Inventors: Benjamin SCHNEIDER, Friedrichshafen (DE); Matthias LIST, Friedrichshafen (DE)

(73) Assignee: ZF FRIEDRICHSHAFEN AG, Friedrichshafen (DE)

(21) Appl. No.: 12/967,397

(22) Filed: Dec. 14, 2010

(30) Foreign Application Priority Data
Jan. 7, 2010 (DE) 10 2010 000 723.4

(51) Int. Cl. F16H 63/34

(52) U.S. Cl. 192/219.5

(57) ABSTRACT

A parking lock device for a motor vehicle which comprises a parking lock gearwheel, a locking pawl, a locking element with an actuating rod and a compensation spring element. In the active zone of the locking element, the locking pawl has an inclined face. The inclined face (1a) has a variable slope angle (α).

This application claims priority from German patent application serial no. 10 2010 000 723.4 filed Jan. 7, 2010.

### FIELD OF THE INVENTION

The invention concerns a parking lock device for a motor vehicle transmission.

### BACKGROUND OF THE INVENTION

It is known to provide automatic transmissions of motor vehicles with a parking lock which, when the vehicle is parked, locks the transmission output shaft relative to the transmission housing and so prevents the vehicle from rolling away. A review of commonly available parking locks can be found in the technical handbook “Fahrzeuggetriebe” [Vehicle Transmission] by Harald Naunheimer et al., 2^{nd} Edition 2007, pp. 368-373. The basic principle of a parking lock is that a locking pawl engages radially in a parking lock gearwheel, the pawl being actuated via a compensation spring by a locking element such as a locking roller or locking cone. The compensation spring is arranged on a connecting or actuating rod and is pre-stressed when the parking lock is engaged, i.e. the locking pawl has to be raised so that, with its pawl tooth, it engages in a tooth gap of the parking lock gearwheel. If a tooth-on-tooth position occurs locking is not possible, but the locking pawl is then acted upon by the compensation spring so that any farther relative movement between the pawl tooth and the parking lock gearwheel allows the tooth to drop into a tooth gap. The pre-stressing of the compensation spring decreases with increasing travel of the locking element, i.e. the lifting force that acts upon the locking pawl also becomes smaller. The compensation spring must therefore be made strong enough to ensure that at the end of the actuating movement a sufficiently large lifting force is still exerted on the locking pawl. Accordingly, the spring force that acts on the locking element at the beginning of its actuating movement is larger than necessary, i.e. it is excessive.

From DE 199 33 618 A1 by the present applicant a parking lock device for an automatic transmission with a locking pawl is known, which engages, by means of a pawl tooth, in a parking lock gearwheel and locks it mechanically. While the parking lock is engaged, the locking pawl is locked relative to the transmission housing by a locking cone. The locking cone is arranged on a connecting rod and is actuated by it via a spring device referred to above as the compensation spring, i.e. it is pressed against an inclined face on the locking pawl. Thus, the spring device serves in particular to enable axial movement of the locking cone on the connecting element (or connecting rod) if, while engaging the parking lock, a tooth of the locking pawl encounters a tooth of the locking gearwheel so that the locking pawl cannot engage between the teeth of the parking lock gearwheel. As soon as the tooth drops into a tooth gap, the spring load is relieved and under the action of the (decreasing) spring force the locking cone slides to its final locking position. The rod-like connecting element is then already in its end position and moves no farther. The inclined face on the locking pawl is as a rule flat and positioned at an angle of around 45 degrees relative to the movement direction of the locking cone. By virtue of the oblique face, a lifting force is exerted on the locking pawl, which acts in opposition to the force of the restoring spring (lever spring) of the locking pawl.

From the older German application by the present applicant with file number 10 2008 054 467.1 a parking lock device for a motor vehicle transmission is known, with a locking pawl and a locking cone arranged on an actuating rod. From the drawings it is easy to understand how the locking cone and the locking pawl cooperate by virtue of the flat inclined face located on the underside (the back) of the locking pawl.

### SUMMARY OF THE INVENTION

The purpose of the present invention is to provide a parking lock device of the type mentioned above, such that the lifting force exerted on the locking pawl remains as constant as possible when the parking lock is being engaged.

According to the invention, the inclined face has a variable slope defined by an angle α. This variable slope lies in a plane extending between an x-axis and a y-axis, the x-axis being the movement direction of the locking element and the y-axis being the lifting direction of the locking pawl. The angle α is formed between a tangent to the inclined face and the x-direction. The movement direction of the locking element as the parking lock is being engaged is regarded as the positive x-direction. Along this positive x-direction, the angle α of the slope decreases. This has the advantage that the decreasing spring force is compensated by a slope angle that is becoming smaller, i.e. the smaller the spring force acting in the x-direction, the larger the transmission ratio.

According to a preferred embodiment the inclined face is made as a cambered surface, i.e. it is convexly curved so as to produce a continuously decreasing angle α. The inclined face is preferably formed as a two-dimensional surface, i.e. sections parallel to the x-y plane have the same contour for the inclined face. This results in linear contact, for example in the case of a locking element in the form of a locking roller.

In a particularly preferred embodiment, the angle α varies in accordance with an arctan function, so that the angle α or slope decreases as the force of the compensation spring becomes smaller. This has the advantage that despite the decreasing spring force, a constant lifting force (in the y-direction) is exerted on the locking pawl.

### BRIEF DESCRIPTION OF THE DRAWINGS

An example embodiment of the invention is illustrated in the drawing and explained in more detail below; further features and/or advantages emerge from the description and/or from the drawing, which shows:

FIG. 1: Section of a parking lock device of the prior art, and

FIG. 2: Locking pawl according to the invention, with a variable slope.

### DETAILED DESCRIPTION OF THE PREFERRED EMBODIMENTS

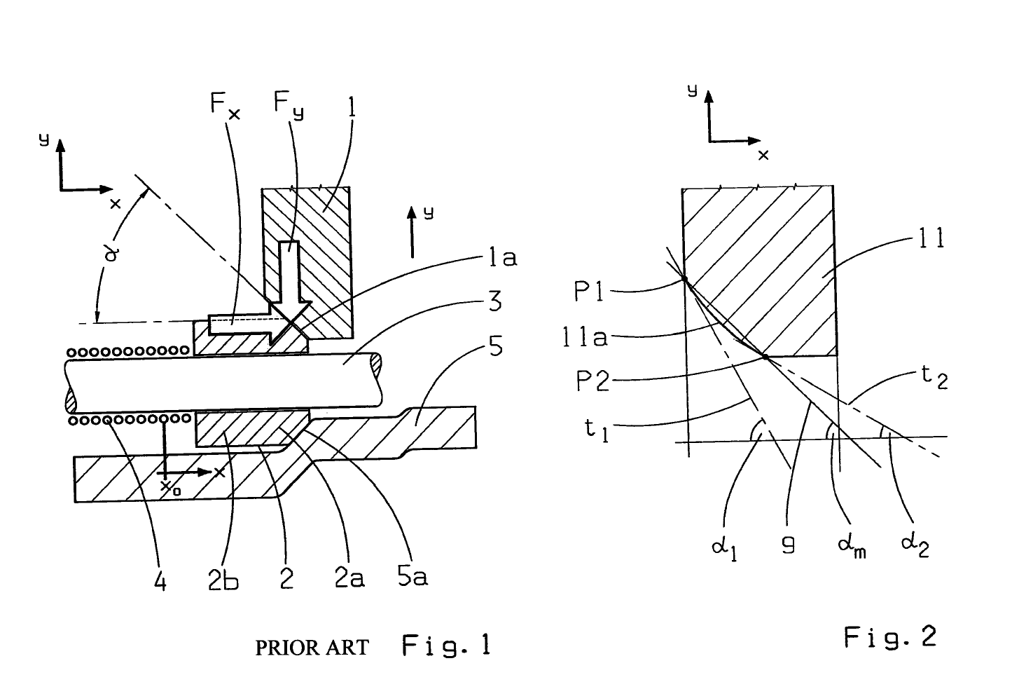

FIG. 1 shows a section of a parking lock device of the prior art. A locking pawl 1 is partially shown in cross-section, i.e. with its lower area which has an inclined face 1a. The sectional view shown in FIG. 1 is in a plane determined by the coordinates x (horizontal in the drawing) and y (vertical in the drawing). The inclined face 1a, which is a flat surface, forms with the x-direction an angle α which is generally of the order of 45 degrees. Acting in co-operation with the inclined face 1a is a locking element in the form of a locking cone 2, which is mounted to slide on an actuating or connecting rod 3. The locking cone 2 is loaded by a compensation spring 4, hereinafter ‘spring 4’ for short, so that it is pressed against the inclined face 1 a of the locking pawl 1. The locking cone 2 has at its front end a truncated cone-shaped area 2a and, behind that, a cylindrical or slightly tapered section 2b. The parking lock device also comprises a guide plate 5 which is supported on a transmission housing (not shown) and has an obliquely extending supporting surface 5a. In the position shown in the drawing, the locking cone 2 rests on one side against the supporting surface 5a fixed on the housing and on the other side against the inclined face 1a of the locking pawl, and is at the same time loaded in the x-direction by the compensation spring 4. This position is adopted when the parking lock is engaged, such that the locking pawl 1 moves in the direction of the arrow Y, i.e. in the radial direction of a parking lock gearwheel (not shown). The force of the locking cone 2 that acts in the x-direction, produced by the pre-stressing of the compensation spring 4, is represented by an arrow Fₓ. This force Fₓ on the inclined face 1a acts in opposition to a force F_{y} again indicated by an arrow, which results from the restoring force of a restoring spring (not shown), preferably in the form of a lever spring.

When the parking lock is being engaged, by virtue of the spring force Fₓ the locking cone 2 exerts on the locking pawl a lifting force in the Y direction, which must be larger than the restoring force F_{y}. This lifting force depends on the angle α of the inclined face 1a relative to the x-direction, i.e. the smaller is the angle α the larger is the lifting force that acts on the locking pawl 1. When the parking lock is being engaged, the actuating rod 3 first moves to an end position such that at the same time the compensation spring 4 acting on the locking cone 2 is pre-stressed. The pre-stress, which is greatest at the position x₀, causes the locking cone 2 arranged to slide on the actuating rod 3 to move in the x-direction. As the locking cone 2 continues its movement the pre-stress in the compensation spring 4 is progressively relieved, i.e. the pressure force on the locking cone 2 decreases in accordance with the equation F=c·x. Accordingly, the lifting force on the locking pawl 1 also decreases. This is where the invention comes into its own, since its result is that during the movement of the locking cone 2 in the x-direction the lifting force does not decrease but remains at an at least approximately constant force level.

FIG. 2 shows a locking pawl 11 designed according to the invention, with a convexly curved inclined face 11a which—analogously to the prior art illustrated in FIG. 1—is positioned in the action area of a locking element (not shown in FIG. 2). This element can be a locking cone or a locking roller. The curved inclined face 11a is preferably made as a two-dimensional surface extending perpendicularly to the plane of the drawing. Thus, all sections parallel to the plane of the drawing have the same convexly curved contour. The curved inclined face 11a is characterised by a slope angle α that decreases in the x-direction—indicated by the co-ordinate intersection x-y. To make this clear, tangents t1, t2 are drawn at the points P1 and P2, i.e. at the beginning and end of the inclined face 11a, these tangents intersecting the x-direction at respective angles α1 and α2 such that α1>α2. For comparison with the prior art, a line g has also been drawn, which intersects the x-direction at an angle αₘ equal to 45 degrees. Due to the variable angle α, as the locking cone moves in the x-direction the transmission ratio of the lifting force in the y-direction acting on the locking pawl 11 increases. Thus, the decreasing pre-stress of the compensation spring 4 (see FIG. 1) is compensated. The relevant derivation is shown below.

As is evident from the representation shown in FIG. 1, the relationship between the horizontal force Fₓ acting on the locking element 2 and the vertical force F_{y} acting on the locking pawl 1 is as follows:

F_{y}=Fₓ·tan α

Since the horizontal force Fₓ acting on the locking element 2 depends on the pre-stress in the compensation spring 4, this force decreases in the x-direction as shown by the following equation:

Fₓ=Fₓ₀−c·x

The force Fₓ₀ is the maximum pre-stress force at the point x₀ (see FIG. 1). Thus, the pre-stress decreases in accordance with the term c·x (the spring constant times the path traveled).

The angle α of the inclined face 11a in FIG. 2 can be described by the following function:

A=arctan F_{y}/Fₓ=arctan F_{y}/(Fₓ₀−c·x)

If the variation of the angle α is designed in accordance with this function, there will be a constant lifting force F_{y} on the locking pawl 1. (For the sake of simplicity the vertical force acting in the −y direction and the lifting force acting in the +y direction are both denoted as F_{y}.)

This ensures that the lifting force F_{y} at the end of the locking element's travel path is still large enough to press the tooth of the locking pawl into a tooth gap of the parking lock gearwheel and to prevent so-termed juddering, in which the tooth of the locking pawl rattles across the teeth of the parking lock gearwheel.

Concerning further details of a parking lock device, reference should be made to the document DE 199 33 618 A1 mentioned earlier, the entire disclosure content of which is hereby incorporated in the present application by reference thereto.

### INDEXES

1 Locking pawl

1a Inclined face

2 Locking cone

2a Front area of locking cone

2b Rear area of locking cone

3 Actuating rod

4 Compensation spring

5 Guide plate

5a Supporting surface

11 Locking pawl

11a Convexly curved inclined face

Fₓ Horizontal force

F_{y} Vertical force

Fₓ₀ Maximum pre-stress force

α, α1, α2 Slope angle

P1, P2 Points on the inclined face 11a

t₁, t₂ Tangents

g Line

1-6. (canceled)

7. A parking lock device for a motor vehicle, the parking lock device comprising:
a parking lock gearwheel,
a locking pawl (1; 11),
a locking element (2) with an actuating rod (3), and
a compensation spring element (4) such that, in an active zone of the locking element (2), the locking pawl (1; 11) having an inclined face (1a; 11a), and the inclined face (1a; 11a) having a variable slope.

8. The parking lock device according to claim 7, wherein the variable slope is defined by an angle (α) formed by a tangent (t₁, t₂) to the inclined face (11a) and a movement direction (x) of the locking element (2).

9. The parking lock device according to claim 8, wherein the angle (α) decreases in a positive x-direction.

10. The parking lock device according to claim 8, wherein the inclined face is formed as a convex surface (11a).

11. The parking lock device according to claim 10, wherein the inclined face is formed as a two-dimensional surface (11a).

12. The parking lock device according to claim 11, wherein the angle (α) becomes smaller as the force of the compensation spring (4) decreases, in accordance with an arctan function.
